(19) United States
(12) Patent Application Publication
(10) Pub. No.: US 2021/0315186 A1
(43) Pub. Date: Oct. 14, 2021

(54) INTELLIGENT DUAL SENSORY SPECIES-SPECIFIC RECOGNITION TRIGGER SYSTEM

(71) Applicant: THE UNITED STATES OF AMERICA, AS REPRESENTED BY SECRETARY OF AGRICULTURE

(72) Inventors: Mahmood R. AZIMI-SADJADI, Fort Collins, CO (US); John HALL, Fort Collins, CO (US); Christopher ROBBIANO, Fort Collins, CO (US); Kurt Christian VERCOUTEREN, Laporte, CO (US); Nathan Paul SNOW, Fort Collins, CO (US); Joseph Martin Halseth, Fort Collins, CO (US)

(21) Appl. No.: 17/230,453

(22) Filed: Apr. 14, 2021

Related U.S. Application Data
(60) Provisional application No. 63/009,611, filed on Apr. 14, 2020.

(51) Int. Cl. A01K 29/00; A01M 25/00; A01K 5/02; G06K 9/00; G10L 25/51

(52) U.S. Cl. CPC A01K 29/00; A01M 25/002; A61D 7/00; G06K 9/00362; G10L 25/51; A01K 5/02

(57) ABSTRACT

An apparatus and method for autonomous and accurate identification of target animal species, such as in animal species control and management systems for use in public or private agricultural and related communities. An intelligent, autonomous, dual-sensory, animal species-specific recognition system useful for activating wildlife management and related devices when a particular animal species approaches the system is provided. The device and method use a combination of both acoustic and visual sensors, together with efficient and robust recognition algorithms and signal/image processing techniques, to maximize accurate target-specific identification and reject false alarms.

### BACKGROUND

Animal species control and management in public and private agricultural and related communities has become increasingly more important. Issues arise in different ways, from attempts to control delivery of feed, dietary supplements, toxicants, vaccines, contraceptives, and other compositions to a variety of animals.

Various approaches have addressed these issues in different settings. U.S. Pat. No. 7,124,707 focuses on selective animal feeding. The disclosed apparatus is particularly suited for pet and livestock owners who prefer to limit access to food by one animal, without allowing access by another animal. For example, a pet owner may want to allow a pet cat to have leisurely access to the cat food, while preventing a pet dog from also eating the cat food. The result is effectively saving the cat food for the cat, while preventing the dog from quickly consuming its own food and the cat food too.

The '707 patent disclosure teaches use of a transmitter and receiver system that requires affixing a transmitter to one of the animals, for example here the cat. The receiver is associated with the food container. When the receiver detects proximity of the cat and its transmitter, the receiver prompts the apparatus to allow access to the cat food, such as by opening a lid. When the cat is not near the receiver/apparatus containing the cat food, the receiver allows the apparatus to close the lid, preventing access to the cat food.

This technology requires close access to the animals at issue. This is not suitable for a situation where the goal includes targeting or tracking all known and unknown wild animals of one or more particular species. Typically, only visual and audio footage may exist, without any close contact at all with the animals, much less ahead of time. Both transient and new young animals may also be involved with some frequency, especially depending on the time of year. Accordingly, pre-tagging each potential animal with a transmitter really is not even a possibility.

A similar selective feeding issue is addressed in U.S. Pat. No. 10,292,363. This disclosure teaches species animal feeders, potentially useful in population control of undesired individual species in a particular location. The concept is intended to allow, for example, feeding of a selected species without also feeding a nuisance species. When a species is recognized by a “species recognition device” relying on sound and/or video, the deterrent used to keep animals away from the feed (such as an electrical shock) is said to be deactivated. For example, the device may be set to open a feeder box when a desired species is recognized.

There are problems with broader use of this technology. First, while a species recognition device is mentioned, the disclosure does not set forth any explicit mechanism for how audio and/or visual data may be used by the “species recognition device.” Furthermore, the design of this technology assumes that feed will be compatible with a gravity feed approach. This is an impractical design for situations requiring non-grain-like feeds and toxicants, such as, for example, a peanut-butter based paste, suspended mixture, or slurry as used in U.S. Pat. No. 9,750,242 (addressing humane baits for controlling feral omnivore populations). In addition, this teaching in the '363 patent clearly contemplates relatively frequent replenishment by the user, to refill the food. Accordingly, there was no need to address an appropriate power supply for the device, which is not appropriate for autonomous 24/7 deployment. A system appropriate for autonomous 24/7 deployment provides many advantages, especially when deployed in remote locations.

A similar species-specific feeder is addressed in U.S. Pat. No. 9,295,225. This technology similarly focuses on feeding a particular group of recognized animals while providing an electrical shock deterrent for non-recognized animals. The feed may be intended to nourish the animals, or to help control their population by including a component in the feed that accomplishes that goal. The species recognition device is said to be a sound recognition component or a video recognition component, pre-configured to identify a species-specific sound or image. Accordingly, the determination of what species is programmed to be recognized is made ahead of time, by a human operator and not an intelligent decision-making system. Thus, this device does not include a redundant identification system including both sound and video recognition and would not be useful for autonomous 24/7 deployment as it requires involvement by a person in the loop.

### SUMMARY

The present subject matter relates to an improved method and device providing an intelligent, autonomous, dual-sensory, animal species-specific recognition system useful for activating wildlife management devices when certain species approach the system. The wildlife management devices can include, without limitation: (1) devices that deliver feed, dietary supplements, toxicants, disease vaccines, contraceptives, or other desired compositions, whether or not masked in baits, to one or more particular groups of animals, and (2) devices designed for trapping, hazing, perimeter control, and other similar devices, all of which are intended to be activated when certain animal species approach the system or device located wherever the user prefers to deploy the device. The deployment location typically would be the area of interest to the user.

The animal species recognition system uses a combination of both acoustic and visual sensors, combined with a suite of highly efficient and robust recognition algorithms, or signal/image processing techniques, implemented on commercially available, off-the-shelf (COTS) hardware. The combination helps maximize target-specific identification and minimize non-target activation, or false alarms, providing explicit intelligent and trainable mechanisms. The resulting system enables autonomous use of the device even over extended periods of time without need for human interaction or on-site supervision.

Of course, the system typically also allows for specific pre-programming for known animal species even before the system is installed in the desired location to be monitored or is re-deployed to another desired location, regardless of whether the system is programmed for autonomous recognition of additional animal species that may encounter the system once it is activated. That is, the system is capable of being both pre-programmed and/or programmed in real time (such as in the field) for the identification of one or more animal species of interest, as well as potentially for identification of animal species that are not of interest but that are expected to be, or that turn out to be, prevalent at the site where the system is deployed. In one embodiment, any programming would typically focuses on species expected potentially to be present in the particular location of interest.

This fully autonomous system provides several advantages by allowing the user to leave the wildlife management devices controlled by the system to be left unattended for extended periods without incurring risk to unintended animal species. Furthermore, users will not need to monitor or service their devices nearly as frequently as is currently the case, much less during all active hours of the animal species of interest—a tedious task that can require significant human-hours but is typically required for accurate, reliable use of current systems.

In one embodiment of the present subject matter, one specific exemplary species with which this subject matter is expected to be particularly useful is Sus scrofa (feral swine). Additional, non-limiting example of species of particular interest either for inclusion or exclusion may include black bears, raccoons, domestic dogs, livestock (such as cattle, sheep, goats, horses), humans, and any other target or non-target animals.

Another embodiment is an animal species recognition system comprising a processor that uses a combination of audio and visual evidence to identify and recognize one or more animal species of interest in real time during deployment of the system.

Another embodiment is a wildlife management device activating system comprising the animal species recognition system comprising a processor that uses a combination of audio and visual evidence to identify and recognize one or more animal species of interest in real time during deployment of the system and subsequently activate the device using a control mechanism.

Another embodiment provides a method of animal species recognition comprising the steps of
configuring an animal species recognition system comprising a processor that uses a combination of audio and visual evidence for recognizing one or more animal species of interest in real time during deployment, wherein the configuration includes the capabilities to observe a surrounding environment to detect nearby target animal species; determine when a target animal species is located near the species recognition system (or potentially when an animal species located near the system is not a target animal species, to avoid further activity by the system); and record when a target animal species is located near the species recognition system;
deploying the animal species recognition system in a desired location; and
allowing the animal species recognition system to perform the observation and determination steps.

Yet another embodiment provides a method of animal species control or management, comprising the steps of
configuring a wildlife management device activating system in connection with a wildlife management device to observe a surrounding environment to detect target animal species near the wildlife management device; determine when a target animal species is located near the wildlife management device; and enable the wildlife management device;
deploying the wildlife management device activating system and the wildlife management device in a desired location; and
allowing the wildlife management device activating system to perform the observation, determination, and enablement steps at appropriate times during the deployment.

### BRIEF DESCRIPTION OF THE DRAWINGS

FIG. 1A provides an external view of an exemplary dual-sensory intelligent engine, depicting the front of the case along with the infrared LED light sensor, the camera lens, the motion sensor/lens, and the microphone sound port.

FIG. 1B provides an internal view of an exemplary dual-sensory intelligent engine, depicting all required bus and line connections between the various critical computing components and the sensors and emitters of the system.

FIG. 2 displays a flow diagram of the information processing utilized by an exemplary fully autonomous dual-sensory system.

FIG. 3 displays a flow diagram of the information processing utilized by an exemplary audio subsystem.

FIG. 4A displays a flow diagram chart of the information processing utilized by an exemplary visual subsystem during a capture video frame stage.

FIG. 4B displays a flow diagram chart of the information processing utilized by an exemplary visual subsystem during a process video frame stage.

FIG. 5A displays exemplary receiver operating characteristics (ROC) curves of an exemplary audio subsystem.

FIG. 5B display exemplary receiver operating characteristics (ROC) curves of an exemplary visual subsystem.

### DETAILED DESCRIPTION OF THE PREFERRED EMBODIMENTS

The system presented provides a novel approach to autonomously identifying one or more animal species of interest, for purposes of feeding, administering a specialized (e.g., toxicant or medication) composition, trapping, logging, or otherwise interacting only with individual wildlife identified as falling within the animal species of interest. This approach uses a dual-sensory intelligent engine that monitors at least two of motion, audio, and video activity at a given location, much like commercially available trail cameras. However, this system is additionally enhanced by a suite of finely tuned inference algorithms which fuse evidence from the dual sensory channels in order to arrive at reliable decisions regarding whether or not individual wildlife should be considered to be within the designated animal species of interest. In one embodiment, this system relies on both audio and visual subsystems, which together help maintain extremely low false-alarm rates where non-targeted species of animals are present in the deployment area.

Using a motion sensor, any triggering of the motion sensor activates the audio subsystem to start capturing streams of acoustic data via a microphone placed in the intelligent device. As soon as the audio subsystem confirms some evidence of activity by a targeted animal species, the visual subsystem is triggered to record a series of image frames containing moving targets. The combination of audio and visual subsystems provides increased accuracy in determining whether a targeted animal species is actually in the vicinity and virtually eliminating the incident of false alarms for non-targeted animals. Alternatively, the motion sensor may be used to activate the visual subsystem directly, such as when one or more target animal species is typically quiet without much vocalization.

A list of components in an exemplary system is included in Table 1.

TABLE 1
Intelligent Dual Sensory Species-Specific Recognition
Trigger System Components

| PART NO. | PART DESCRIPTION | PART NO. | PART DESCRIPTION |
|---|---|---|---|
| 1 | Intelligent Engine (Front View) | 13 | Microphone Signal Wire |
| 2 | Light Sensor | 14 | Embedded Computing Platform |
| | | | (ECP) Power Connector |
| 3 | Infrared LED Flash Array | 15 | Processor/ECP |
| 4 | Infrared LED | 16 | ECP and Peripheral Connectors |
| 5 | Enclosure Latches | 17 | Enclosure Interior (Rear) |
| 6 | Camera Lens | 18 | Enclosure Seal |
| 7 | Motion Sensor Window/Fresnel | 19 | Battery |
| | Lens | | |
| 8 | Microphone Sound Port | 20 | Camera Signal Bus |
| 9 | Enclosure Hinge | 21 | Infrared Motion Sensor Bus |
| 10 | Enclosure Interior (Front) | 22 | Infrared Motion Sensor |
| 11 | Light Sensor Signal Wire | 23 | Camera |
| 12 | Microphone | 24 | Infrared Flash Array Power |
| | | | Connector |

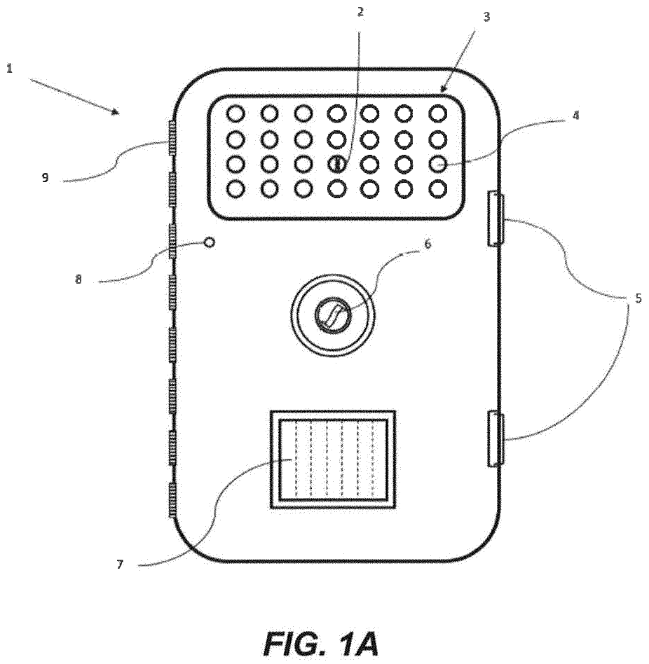

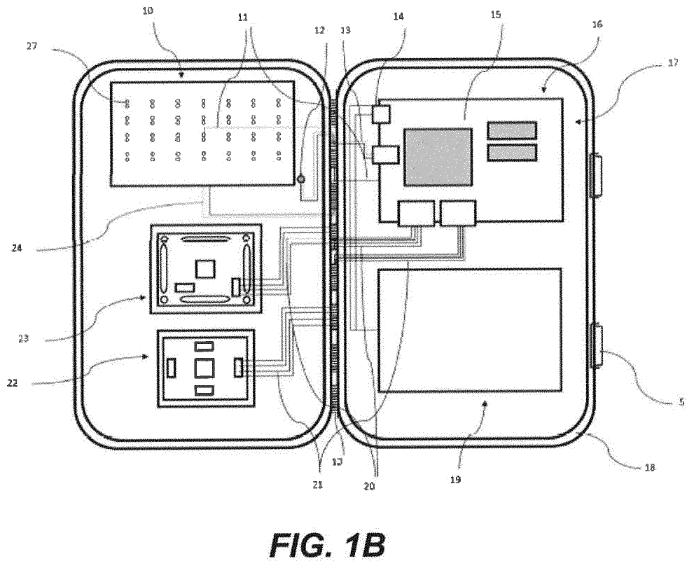

As depicted in FIGS. 1A and 1B, an exemplary dual sensory intelligent engine 1 may be enclosed in a protective casing, for example comprising a front cover, a back cover, and one or more hinges 9 and enclosure latches 5. The front cover would include access ports as may be needed for a light sensor 2, along with infrared LEDs 4 generally arranged in an infrared LED flash array 3. Additional apertures would generally provide access to a camera lens 6, and a motion sensor window/lens 7. There would also be a microphone sound port 8.

The enclosure interior front 10 and enclosure interior rear 17 of the intelligent engine 1 would contain and connect the various identification components. Additionally, a rubber, water-proof enclosure seal 18 can be situated, for example, in a groove along the edge of the mating surface between front 10 and back 17 portions of the enclosure.

Detection of motion by the motion sensor window/lens 7 would activate the system, taking it out of power saving mode and alerting the device to potentially receive audio and visual information. Any detectable audio events are then captured by the enclosure-mounted microphone 12, situated to be able to receive sound pressure from the surroundings through the microphone sound port 8. Detectable video events are captured via the enclosure-mounted COTS camera 23, through the camera lens 6. For optimal performance, the camera may have an infrared filtering lens that can be enabled and disabled at the system's discretion to improve night-time capture image quality.

Motion in the scene may be detected via a Passive Infrared (PIR) motion sensor 22. The PIR motion sensor 22 captures its measurements through the enclosure mounted motion sensor window/lens 7 which may provide, for example, approximately 100° (azimuthally) of coverage with an effective range of about 8 meters. For optimal detection performance, PIR sensors should be configured in single pulse trigger mode. For more energy efficient operation, dual pulse trigger mode may also be used.

Scene illumination, for nighttime operation, may be provided by an Infrared LED flash array 3. At the discretion of the intelligent engine, the infrared LED flash array 3 can be activated while capturing images in low-light situations. The flash array 3 may be comprised, for example, of 20-30 Infrared Light Emitting Diodes (LEDs) 4. In order to determine whether scene illumination is required, a photo-resistive light sensor 2 may be embedded in the IR array board, providing its measurements to the embedded computing platform (processor/ECP 15). The IR Flash array 3 may be enabled via a single digital pin which may connect to a pair of NPN transistors acting as a power source connector 24.

Accordingly, in this embodiment, the interior of the intelligent engine 1 houses all sensors and emitters, and all ECP and peripheral connectors 16. In this manner, the device interfaces with all sensors and emitters, interfacing with these components in order to perform inference and decision making. The ECP 15 can interface with the microphone via a microphone signal wire (or microphone signal bus) 13 and can buffer samples via an onboard (or peripheral) audio card. The ECP 15 may interface with the light sensor 2 via a light sensor signal wire (or single digital pin connection) 11 which can be monitored by the ECP 15's top-level program. The ECP 15 can interface with the camera via a camera signal bus (or serial bus connection) 20 and the infrared motion sensor bus 21. Both the ECP power connector 14 and the IR Flash array power connector 24 may be connected, for example, directly to a SV DC power supply which can be provided either via an internal battery 19 or to an external connection to a power supply located outside the enclosure. In alternative embodiments, any or all of the connections can be made wirelessly.

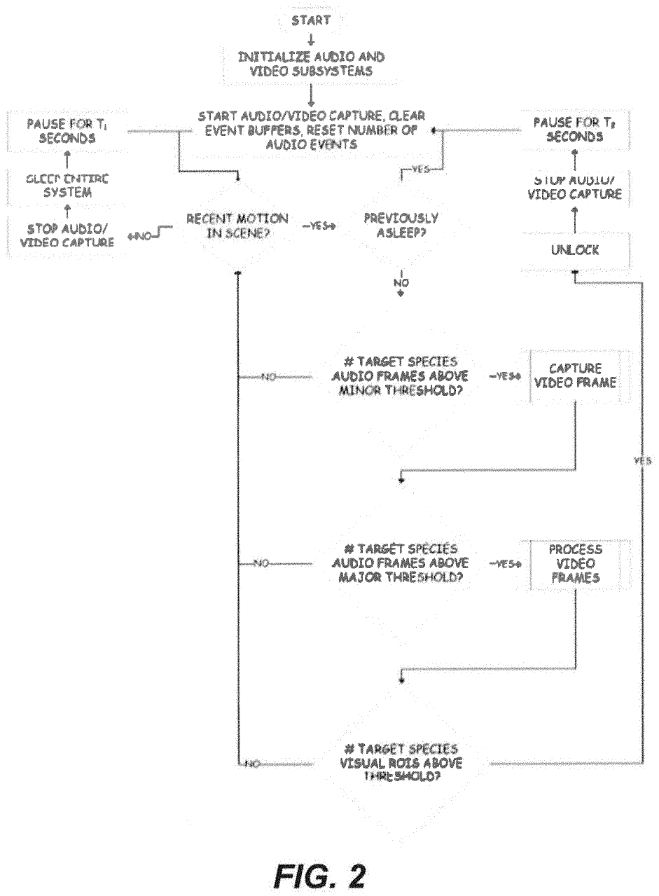

In one embodiment, construction of a device including the core components amounts basically to configuring the components in the manner described in FIGS. 1A and 1B. After components have been suitably placed in the enclosure front 10 and back 17, a top-level program that can implement the decision fusion described in FIG. 2 may be ported to the embedded computing platform. Audio and Visual subsystems are designed to stream data from their respective components and perform event detection and classification on those data streams, wherein the interfaces of the subsystems reveal the critical inference information required to run the top-level decision fusion.

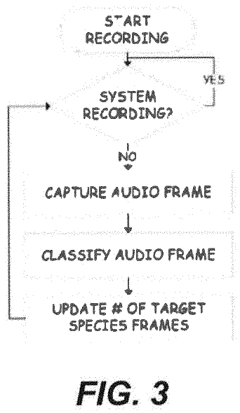

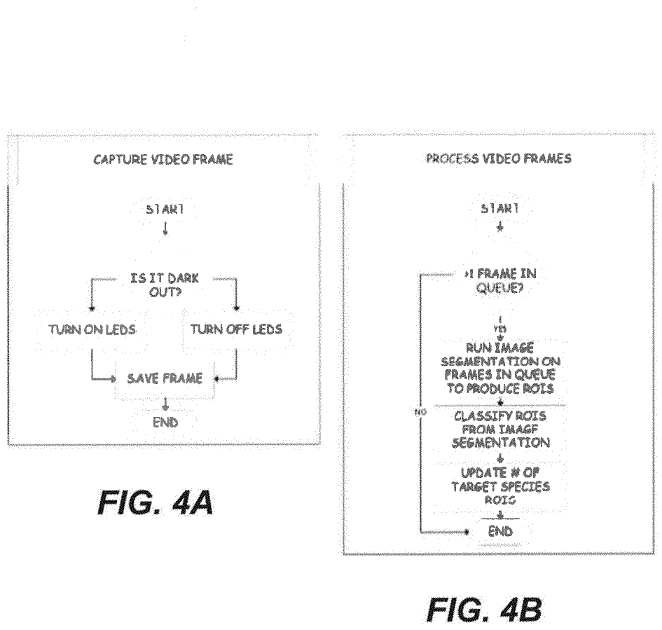

Each subsystem utilizes a neural network-based classifier, specifically trained to determine an inference based on data from their respective channel, in real time, and to provide a buffered queue of events describing the classes identified and the degree of confidence of these decisions. Exemplary flow charts for the audio and visual subsystems are illustrated in FIG. 3 and in FIGS. 4A and 4B, respectively. In addition to running the main inference routine, the embedded processor can be tasked with monitoring motion and light levels in the environment to provide a basis to adjust sensors, to optimize their performance in the current conditions, and determine when the scene is inactive in order to save power by putting the inference subsystems to sleep.

The audio subsystem can be designed to continuously stream audio data from the microphone through the embedded computing platform's audio card, and to simultaneously perform classification of the latest audio data captured to determine if the audio segment contained evidence of an animal species of interest. Additionally, the audio subsystem object can maintain a data structure with the event class labels and the confidence level of all inferences made in the previous several seconds, where the number of seconds is chosen to trade-off between power consumption and typical interval between vocalizations for the species of interest. This data structure can be utilized by the top-level inference algorithm to make decisions about the presence or absence of an animal species in the scene. In one non-limiting example, the number of seconds can be 10 seconds.

The audio channel gain can be adjusted, based upon the ambient noise levels, to a suitable level considering the proximity of the feeder box in the deployment site. The audio subsystem can be responsible for preliminary identification of events where the targeted animal species is present in the scene. Upon triggering of the system's motion sensor, the audio subsystem starts capturing continuous streams of acoustic data, sampled at the specified sampling frequency and bit-depth, both of which are chosen to balance the tradeoff between power consumption and vocalization fidelity, from the surrounding environment. Animals with a narrower-band vocalization Power Spectral Density (PSD) require less rapid sampling to retain high fidelity samples, as addressed by the Shannon sampling theorem. In one non-limiting example, the audio subsystem starts capturing continuous streams of acoustic data sampled at 16 KHz with 16 bits per sample from the surrounding environment.

The acoustic streams can then be partitioned into frames (events) of, for example, 1 second duration with 0.9 second overlap between consecutive frames. Spectral features can be extracted from each audio frame leading to a matrix of spectral-based features which is subsequently used to make species classification decisions. The classifier can be based, for example, on a deep convolutional neural network (CNN), which is specifically trained to distinguish predetermined or programmed target animal species from other, non-target animal species based upon their vocalizations. The non-target animal species may be programmed into the system as a “negative” indication, or merely left as unidentified animal species that do not result in a “positive” indication.

FIG. 3 depicts an exemplary flow diagram for audio data processing. The audio subsystem can collect and make classification decisions on each audio frame, with classification decisions of the most recent selected time interval, such as, for example, the previous 10 seconds, of audio frames being stored. Once a pre-specified number of stored audio frames are classified as the target animal species, the presence of the target animal species in the deployment site is declared. The audio subsystem can be implemented in the Python programming. Other programming languages can also be used as desired. The software can run on an embedded computing platform with an external USB-based audio card used to capture the raw audio to be fed to the Audio classifier, such as, for example, a deep CNN, from a MEMs (micro-electro mechanical) or electret microphone directly wired to the audio-card ⅛″ line in.

The visual subsystem can be designed to stream images from the scene, automatically adjusting camera exposure and frame rate as required by the then-current lighting conditions of the environment. The capturing of images typically begins once the audio subsystem has classified a percentage of the stored audio frames as including at least one of the target animal species, but before the audio subsystem has declared the presence of the target animal species in the deployment site. This is the capture-only mode. The capture and inference mode typically begins once the audio subsystem has declared the presence of the target animal species in the deployment site. Image capturing ceases when there is no target animal species in the scene or an unlock event occurs.

In the capture-only mode, the visual subsystem typically will simply maintain a queue of the latest frames captured in the most recent selected time interval, such as, for example, the previous 10 or 12 seconds. In capture and inference mode, this subsystem will typically continue adding to the queue of images captured, and additionally classifying subregions of each image. The subregions are regions of interest (ROIs) that get passed to the neural network-based visual classifier subsystem. This mode typically stores an image queue of full frames, an image queue of ROIs, and a data structure indicating the class-label and confidence level of the selected ROIs in the queue.

Exemplary processing flow diagrams for the visual subsystem can be seen in FIGS. 4A and 4B. The Optical Flow (OF) algorithm can be applied to sequential pairs of images to identify targets in an image and produce the ROIs. Each ROI extracted from an image is processed through another classifier, which classifies the ROI as one of many possible animal species. If any of the ROIs from an image is classified as a target animal species, then that image is labeled as containing the target animal species.

A consistency mechanism is performed on labels extracted from frames in the queue. If this process leads to a value that is above some pre-determined threshold, then the visual subsystem declares that there is a target animal species in the scene. The visual classifier used in the visual subsystem can be designed for use on mobile and embedded-vision processing platforms with limited processing resources.

The visual classifier used in the visual system may be pre-trained on a large, publicly available image dataset. Transfer learning can then be applied to replace the top layer of the classifier with target classes relating to expected classes to be focused on by the particular visual subsystem as may be appropriate for the situation, and to fine tune the classification performance by training with an augmented training set featuring samples of non-target animal species and target animal species for the intended application.

Inclusion of both target and non-target data may help enable the subsystem to more accurately determine whether a target animal species is present, based on both positive and negative determinations by the subsystem. Such inclusion may allow for three different determinations by the subsystem once any animal species is found to be present:
a positive determination that the present animal species is a target animal species;
a “confirmed” negative determination that the present animal species is not a target animal species, but is a non-target animal species; and
an “unconfirmed” negative determination simply that the present animal species is not a target animal species.

Preferably both the audio and visual classifiers should be trained using data representative of all animal species of interest as well as common sources of interference or confusion in the application setting—including non-desired animal species expected to also be in the vicinity from time to time. Data should be formatted in the same manner as described for operation. Particularly, visual datasets must have sufficiently high frame rates to allow the optical flow pre-processing to capture meaningful ROIs, and all ROIs generated from footage containing a given species should be assigned the corresponding class label. In some embodiments, audio datasets should be organized by class label and contain isolated vocalizations or sounds unique to the animal species and to the interference sources of interest or otherwise anticipated in the deployment location(s).

To combine the decisions of the audio and video subsystems and provide confusion-free animal species identification, a fusion mechanism should be developed and implemented. One exemplary fusion mechanism adopted is a sequential voting process which collaboratively uses a running real-time queue of visual and audio events to determine if there is sufficient confidence in the target animal species class to warrant an “unlock command” for the bait box control system. The sequential decision process for producing an unlock command can be seen in the exemplary flow diagram of FIG. 3. Each individual subsystem must declare and agree that the target animal species has been found within the deployment site, through their individual methods as described previously.

Power for the system may be provided by any power source suitable for use in the desired deployment environment. Examples include, without limitation, suitable batteries, solar powered cells or power source, and hard-wired power supply. The power supply should be sufficient for the desired use, including for example taking into consideration the desired length of time without human intervention; anticipated frequency of activation by motion nearby; and the anticipated duration of use during each activation.

### Example 1—Bears

Several prototype systems have been subject to field deployments in many different sites. A May 2019 deployment in the Nashville, Tenn. area was primarily to test the systems' false alarm performance against local bears. The systems were relocated after each confirmed bear encounter, or after several consecutive days of inactivity, in order to maximize exposure to different bears and testing conditions.

The dual-sensory systems were deployed in 6 different sites. The systems in two of the sites experienced several visits by American black bears during the deployment. Table 2 lists the site names and duration of deployment at each site along with indication of the presence or absence of bears during the deployment period.

Throughout these deployments a total of two unlock events were registered, both of which corresponded to false alarms from human activities that were triggered during setup. Both false alarm events occurred for one system during deployment at Storie Place. Despite repeated visits to sites by black bears, the systems woke several times but never received sufficient audio evidence of a targeted animal species to begin capturing photos from bears (or any other species) for the duration of the field test.

As a result, this testing was deemed very successful to illustrate the false alarm rejection capability for bears.

TABLE 2
TN Field Test Site Activity.

| | | | | USDA | | | |
|---|---|---|---|---|---|---|---|
| | | | Systems | Cams | | Proper | |
| | | Bears | Captured | Captured | System | Brain | |
| Dates | Site | Present? | Bears? | Bears? | Unlock? | Operation? | Notes |
| May 06, 2019 | Bait-site S1 | X | X | X | X | ✓ | |
| to | | | | | | | |
| May 08, 2019 | | | | | | | |
| May 08, 2019 | Bait-site 1 | X | X | X | X | ✓ | |
| to | | | | | | | |
| May 15, 2019 | | | | | | | |
| May 15, 2019 | Bait-site 2 | X | X | X | X | ✓ | |
| to | | | | | | | |
| May 18, 2019 | | | | | | | |
| May 18, 2019 | Bait-site 3 | ✓ | X | ✓ | X | ✓ | Audio never |
| to | | | | | | | detected |
| May 28, 2019 | | | | | | | species of |
| | | | | | | | interest (feral |
| | | | | | | | swine) so |
| | | | | | | | visual processing |
| | | | | | | | did not occur |
| May 06, 2019 | Bait-site S2 | X | X | X | X | ✓ | |
| to | | | | | | | |
| May 08, 2019 | | | | | | | |
| May 09, 2019 | Bait-site 4 | ✓ | X | ✓ | X | ✓ | Audio never |
| to | | | | | | | detected |
| May 22, 2019 | | | | | | | species of |
| | | | | | | | interest (feral |
| | | | | | | | swine) so |
| | | | | | | | visual processing |
| | | | | | | | did not occur |

### Example 2—Feral Swine

Multiple testing deployments on pre-collected audio and visual data sets have successfully been performed. The test files featured varied collections of vocalizations and images of both feral swine and non-target animals that may be anticipated in the same environment. These laboratory tests resulted in the development of the receiver operating characteristics (ROC) curves of both audio and visual systems, depicting the performance of these subsystems in terms of the plots of the probability of correct classification “P_{D}” of feral swine versus the false alarm probability “P_{FA}.”

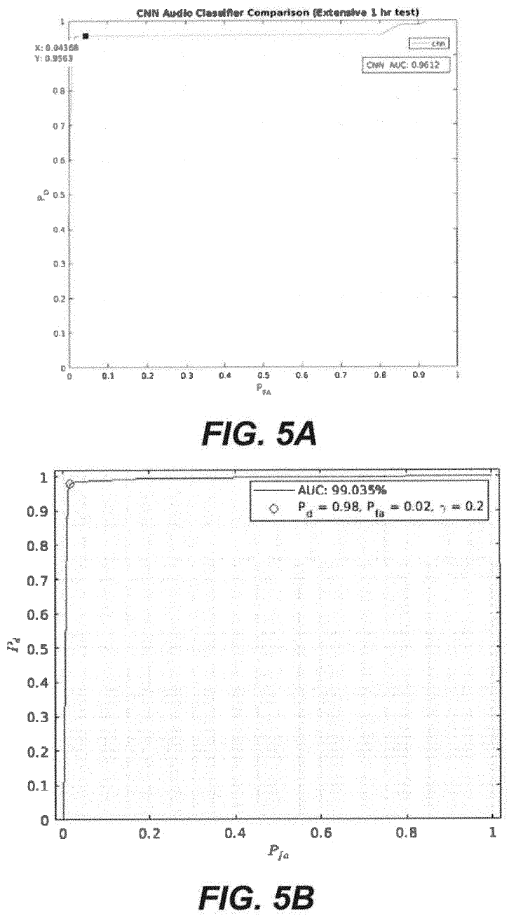

FIGS. 5A and 5B show ROC curves of both subsystems. For the audio classifier the knee-point (at which P_{D} P_{FA}=1) of the ROC curve in FIG. 5A exhibits P_{D}=95.63%, and P_{FA}=4.368%. The audio classifier alone can provide the P_{FA}=0% while still maintaining P_{D}=60%, which is deemed to be acceptable. The visual subsystem's performance for determining if there is a target species, in this case feral swine, in the scene is given by the second ROC curve, in FIG. 5B, which shows P_{D}=98% and P_{FA}=2% at the knee-point of the ROC curve. The two subsystems together provide almost perfect decision-making based upon the pre-recorded data.

More recently, two field deployments were conducted in Texas. In the first of these deployments, two prototype systems were deployed for a 5-day period during the end of February and beginning of March in 2020. The systems were deployed at a ranch in Texas. Prior to this deployment, four candidate sites were pre-baited using feeder boxes that are almost identical to those of the dual-sensory systems, but that lack any latching mechanisms or control logic. During the deployment, the two dual-sensory systems encountered the target feral swine species almost every night of testing, along with a variety of non-target species.

As a method of confirming the deployment results, time lapse trail cameras were also deployed at each of the sites. During deployment, the prototype systems with their companion bear-proof bait-boxes were nicknamed “Site 1” and “Site 2”. The deployment site for Site 1 remained the same throughout all testing while Site 2 was moved to a second site on the afternoon of February 28^{th} because pigs had failed to appear at the site the previous night.

The performance of the systems is briefly summarized in Table 3. In this table, the presence of pigs, system recognition of pigs, system unlocks and notes about the nights of deployment are included. The system proved to be very effective in recognizing the presence of target animals, triggering the feeder boxes to be open and available only when the target species were present in the vicinity of the feeder boxes.

TABLE 3
Performance Overview by Night of Deployment-Field Test, Feb. 2020

| | | | | USDA | | | |
|---|---|---|---|---|---|---|---|
| Date | | | Systems | Cams | | | |
| (night | | Pigs | Captured | Captured | System | Proper | |
| of) | Site | Present | Pigs | Pigs | Unlock | Operation | Notes |
| Feb. 26 | Site 1 | ✓ | ✓ | ✓ | ✓ | ✓ | |
| Feb. 26 | Site 2 | ✓ | ✓ | ✓ | ✓ | ✓ | 3 Unlocks recorded but |
| | | | | | | | never accessed by pigs |
| | | | | | | | according to all photo logs |
| Feb. 27 | Site 1 | ✓ | ✓ | ✓ | ✓ | ✓ | |
| Feb. 27 | Site 2 | ✓ | ✓ | ✓ | ✓ | ✓ | USDA Cams did not |
| | | | | | | | capture the bait access |
| | | | | | | | but SenseHog ™ ROIs |
| | | | | | | | captured pigs accessing |
| | | | | | | | for a few minutes |
| Feb. 28 | Site 1 | ✓ | ✓ | ✓ | ✓ | ✓ | |
| Feb. 28 | Site 2 | X | X | X | X | ✓ | Calves, raccoons, quail, |
| | | | | | | | but no pigs. moved |
| | | | | | | | to R18 Site |
| Feb. 29 | Site 1 | ✓ | X | ✓ | X | X | System Hard-Faulted |
| Feb. 29 | Site 2/R18 | ✓ | ✓ | ✓ | ✓ | ✓ | |
| Mar. 1 | Site 1 | X | X | X | X | ✓ | System was pulled about |
| | | | | | | | 5:50 PM-no pigs had yet |
| | | | | | | | been identified |
| Mar. 1 | Site 2/R18 | ✓ | ✓ | ✓ | ✓ | ✓/X | System was not re-latched |

Data captured from the field deployment demonstrated that the addition of an external lighting source, together with modification to the software, greatly improved image segmentation and consequently visual inference accuracy. In this study, small adjustments were made to the visual and audio subsystem decision thresholds. However, neither the weight of feed set nor feed consumed were measured. In the following study, we included the threshold variations, and kept track of the variables, too, in order to allow comparison of the consumption rate compared to a dummy box with no lock or intelligent control mechanism.

### Example 3—Feral Swine II

Two prototype systems were deployed for a 10-day period during July of 2020. The systems were again deployed at a ranch in Texas. Prior to deployment, ten candidate sites were pre-baited using feeder boxes that are almost identical to those of the dual-sensory systems but lacking any latching mechanisms or control logic. During the deployment, the two dual-sensory systems encountered the target species every night during the testing along with a variety of non-target species including deer, raccoons, cows, turkeys, quail, and roadrunners.

This deployment differed from the study reported in Example 2 above in a number of ways. Particularly, adjustments to the system thresholds were made, and feed consumption and placement was more carefully monitored, following the criteria determined in the original study design. The design steps in this study are briefly summarized as follows:
1) Pre-bait 10 different sites using dummy boxes. Once pigs are accessing the dummy boxes well, begin collecting data
2) Collect 1-2 days of “pre” data using the dummy boxes, including:
   a. Number of pigs/hour
   b. Number of attempts to open
   c. Number of successful openings
   d. Weight of feed consumed (kg)
3) Deploy the smart boxes, with 10 kg of dry kernel corn each set at the “Knee Point” threshold for 1 night, and collect the same data as above
4) Adjust the settings for the next night, depending on how well pigs accessed the box the previous night
   a. If pigs accessed well (i.e., consume >50% of the bait by weight), increase the settings to “False Alarm Resistant” mode and collect the same data as above
   b. If pigs did not access well (i.e., consume <50% of the bait by weight), decrease the settings to “Missed Detection Resistant” mode and collect the same data as above
5) Move the smart boxes to a new site that is pre-baited and ready to go
6) Test 8-10 bait sites over a two-week period
7) In the event of a box malfunction (e.g., corn gets jammed in a latch, visual subsystem failure, etc.) we try again at the same site for another night

This deployment provided thorough testing of the software and hardware modifications that were made since the initial dual-sensory prototypes deployment. The results of the deployment demonstrated nearly perfect operational performance with regard to the target animals. The results of the deployment for each night are reported in Table 4. With the exception of two operator errors early in testing and one night, where a minor mechanical failure prevented optimal access to the bait-box by juvenile pigs, the system performed exceedingly well, opening for only targeted species, and consistently opening for this species almost every night of visitation.

TABLE 4
Performance Overview by Night of Deployment-Field Test, Jul. 2020

| | | | USDA | | | | |
|---|---|---|---|---|---|---|---|
| Date | | System | Cams | Feed | | | |
| (night | | Captured | Captured | Consumed | System | Proper | |
| of) | Site | Pigs | Pigs | (kg) | Unlock | Operation | Notes |
| Jul. 15 | Site 1 | X | ✓ | 0 | X | X | Pigs attempted to access, |
| | | | | | | | Fences caused poor visual |
| | | | | | | | subsystem performance |
| Jul. 16 | Site 2 | ✓ | ✓ | 8.4 | ✓ | ✓ | |
| Jul. 16 | Site 1 | ✓ | ✓ | 0 | ✓ | ✓ | 3 unlocks registered, |
| | | | | | | | re-positioned cameras |
| Jul. 17 | Site 1 | ✓ | ✓ | 8.6 | ✓ | ✓ | |
| Jul. 17 | Site 2 | X | ✓ | 0 | X | X | Multiple Attempts to access |
| Jul. 18 | Site 3 | ✓ | ✓ | 10 | ✓ | ✓ | |
| Jul. 18 | Site 4 | ✓ | ✓ | 1.25 | ✓ | ✓ | |
| Jul. 19 | Site 4 | ✓ | ✓ | 7.25 | ✓ | ✓ | |
| Jul. 19 | Site 3 | ✓ | ✓ | 1 | ✓ | ✓ | |
| Jul. 20 | Site 5 | ✓ | ✓ | 1.75 | ✓ | ✓ | |
| Jul. 20 | Site 6 | ✓ | ✓ | 6.2 | ✓ | ✓ | |
| Jul. 21 | Site 5 | ✓ | ✓ | 10 | ✓ | ✓ | |
| Jul. 21 | Site 6 | ✓ | ✓ | 10 | ✓ | ✓ | |
| Jul. 22 | Site 7 | ✓ | ✓ | 6 | ✓ | ✓ | One side was unlatched on |
| | | | | | | | first contact with the hogs. |
| | | | | | | | System Registered an Unlock |
| | | | | | | | about 3 minutes later |
| Jul. 22 | Site 8 | ✓ | ✓ | 10 | ✓ | ✓ | |
| Jul. 23 | Site 7 | ✓ | ✓ | 7.5 | ✓ | ✓ | |
| Jul. 23 | Site 8 | ✓ | ✓ | 10 | ✓ | ✓ | |
| Jul. 24 | Site 9 | ✓ | ✓ | 3 | ✓ | ✓ | Pigs accessed both sides. |
| | | | | | | | Juvenile pigs had trouble |
| | | | | | | | opening right side. |
| Jul. 24 | Site 10 | ✓ | ✓ | 10 | ✓ | ✓ | |
| Jul. 25 | Site 9 | ✓ | ✓ | 2 | ✓ | ✓ | Pigs accessed both sides. |
| | | | | | | | Juvenile pigs again had |
| | | | | | | | trouble opening right side |
| Jul. 25 | Site 10 | ✓ | ✓ | 9.8 | ✓ | ✓ | |

### Example 4—Wildlife Management Devices

The intelligent, autonomous, dual-sensory, species-specific recognition systems can be used, for example, to activate devices for delivering feed, dietary supplements, toxicants, disease vaccines, or contraceptives masked in baits as well as trapping devices, hazing devices, and perimeter control devices (hereafter referred to as “wildlife management devices”) to wildlife, livestock or pets. Specific examples of any use intended to activate only for certain species in a given area include, without limitation: bait stations for administering one or more toxicants, baits, contraceptives, or other forms of treatment; any desired electrically, mechanically, or electromechanically triggered trapping or hazing system; or population density and flow estimation for species that are difficult to track.

To maximize target-specific identification and minimize non-target activation (false-alarms) of management devices, the system utilizes both acoustic and visual sensors together with a suite of highly efficient and robust recognition algorithms.

As noted above, the flexible choices for supplying power to these systems enable their potential use for long-term wildlife management without regular or frequent need for human interaction or on-site supervision. For example, use of a suitable power source, such as for example solar powered cells or panels, may enable the system to be used for extended periods of time. A bait station, for example, could be protected from non-target species for a long duration without needing human intervention. Similarly, hazing or perimeter control devices could be connected to a suitable power source to enable long term independent use. Devices used to open and close one or more gates, for example, could be used to feed or treat target species while excluding non-target species for extended periods of time limited by the amount of feed or treatment present, rather than any need to maintain the system itself.

One specific example would be to enable cattle to feed while excluding deer, by programming the device to open a feed access door when the target species is present, but to close the door when non-target species are identified. This could be done for any reason, including without limitation to help control the spread of bovine tuberculosis (often linked to cattle and deer).

### Example 5—Detailed Real-Time Situational Awareness in a Baiting Station

FIG. 2 illustrates an exemplary flow diagram representing the high-level concept of the proposed intelligent dual-sensory solution that provides real-time in situ situational awareness. The sensor node serves as the intelligent agent tasked with determining if the interacting animal in the baiting zone is a member of the targeted invasive species. In a preferred configuration, the components interact and operate as follows.

1. The sensor and embedded processing capabilities observe the surrounding environment to detect animals near the bait delivery system.

2. The node uses its real-time observations to orient the decision-making to the current scenario and available actionable decisions. Orientation involves the translation of sensor measurements into representations exploiting data patterns unique to the targeted species. Through orientation, the system may conclude there is an actionable scenario.

3. The possible scenarios are analyzed to reach a decision.

4. The decision triggers a subsequent call to action enabling, for example, the baiting system. This observe-orient-decide-act method is a proven approach used across multiple industries and provides the framework by which the deployed sensor node delivers the correct situational awareness and error-free commands to the managed device.

The combination of audio and video sensing channels, data processing, and decision-making are needed for confusion-free animal recognition and active control to unlock or lock, for example, a bait delivery mechanism. Additionally, sensors on the baiting system provide information and control feedback for verification that bait was taken within an allowed time limit. The entire automated species identification can be implemented using a suite of simple, cost-effective, commercially available off the shelf (COTS) boards that provide real-time measurements and decision-making of the distinct vocal characteristics of animals expected to potentially approach the bait feeder box.

The audio subsystem (such as used in FIG. 2) may utilize a microphone placed in the environment near the feeder box. The audio channel gain is adjusted to a level suitable, based upon the expected ambient noise levels, in the proximity of the feeder box in the deployment site. The audio subsystem is responsible for preliminary identification of events where the targeted species is present in the scene. Upon triggering of the system's motion sensor, the audio subsystem starts capturing continuous streams of acoustic data collected at the specified or pre-determined bit-depth and sampling frequency from the surrounding environment. The acoustic streams are then partitioned into, for example, frames (or blocks) of 1 second duration with 0.9 second overlap between consecutive frames.

Spectral features are extracted from each audio frame using the Mel Frequency Cepstral Coefficients (MFCC) leading to a feature matrix of the MFCC coefficients which is subsequently used to make species classification decisions. The audio classifier, which may be, for example, a deep convolutional neural network (CNN), may be specifically trained to distinguish targeted animals from any other species anticipated to be in the area based upon their vocalizations.

FIG. 2 depicts the entire process for audio data processing. The audio subsystem may be implemented in the Python programming language using the SciPy, Numpy, and TensorFlow libraries. The software runs on a Raspberry Pi 3 with an external USB-based audio card used to capture the raw audio to be fed to the Audio classifier, such as a CNN or other probabilistic classifier, trained on MFCC features. The classifier may be specifically trained, for example, from a MEMs (micro-electro mechanical) microphone directly wired to the audio-card ⅛″ line in.

For example, the audio classifier may be trained using labeled audio snippets that are transformed into their MFCC feature representations. The audio snippets may be taken from, for example,
a database that meets the specified sampling rate and bit-depth or higher,
or the audio could be collected from the device itself, using its onboard MEMs.
   The collected and dated samples could then be recorded to the ECP, and later labeled by hand (as was done here).

The audio subsystem continues to collect and make animal classification decisions on the audio frames. Once a pre-specified threshold is reached, the audio subsystem declares the presence of the targeted species and requests confirmation from the visual subsystem. At this point, the visual subsystem processing is initialized.

As mentioned above, the visual subsystem is triggered as soon as the audio subsystem indicates some evidence of targeted animal activity in the vicinity of the feeder box. The visual subsystem may be composed, for example, of a camera, designed to be deployed outdoors, placed in the same enclosure. Since the background scene does not vary much frame-to-frame, a segmentation algorithm is designed to identify regions of interest (ROIs) in a series of contiguous captured image frames that contain moving targets. Using a segmentation-then-classification strategy as shown in FIG. 3, the visual subsystem may then proclaim the presence of a desired target in the scene.

The Optical Flow (OF) algorithm is applied to pairs of captured images to identify and isolate the ROIs that contain moving targets in the foreground of an image. The OF algorithm produces a set of ROIs with each indicating where possible targets may exist in the current image frame. Each ROI extracted from an image frame is then processed through another visual classifier which classifies the ROI if it includes one of the many expected classes of animals Each frame is labeled as either containing a desired targeted species or other species. If the set of ROIs extracted from an image frame contain at least one desired target then the label is marked as a 1; otherwise it is marked as a 0. A moving average is performed on labels extracted from several consecutive frames. If the computed moving average is above some pre-determined threshold then the visual subsystem declares that a desired target is present in the scene.

The visual classifier used in the visual subsystem may be a derivative of the MobileNet architecture designed for use on mobile and embedded-vision processing platforms with limited processing resources. For example, a CNN model may be built from models provided by TensorFlow and may be pre-trained on the ImageNet (ILSVRC-2012-CLS) dataset. Using region specific data collected by the user or operator, transfer learning may be applied to replace the top layer of the deep CNN (or other visual classifier) with target classes relating to expected classes seen by the specific visual subsystem. The visual subsystem may be implemented in the Python programming language using the OpenCV, Numpy, and TensorFlow libraries. The software may run on a Raspberry Pi 3 with a Google AIY Vision Bonnet used to hardware accelerate the computation speed of the visual classifier.

The fusion system used may be the top-level processing agent of this hierarchical system. The fusion mechanism operates utilizing the decisions of both audio and visual subsystems and is responsible for defining thresholds, video and audio buffer lengths, and the final decision rule for interacting with the hardware latches in the feeder box or other device being controlled. The block diagrams in FIGS. 4A and 4B demonstrate and exemplify the flow of information from the two available sensory channels and the criteria that must be met in order for a system unlock to occur. Namely, once the unlock criteria described for the two subsystems are met together, a fusion algorithm executes the unlock command. The fusion algorithms also may be built in Python 3, using libraries common to both sensory subsystems and operating, for example, on a Raspberry Pi 3 B.

### General Applicability—Advantages of the Present System

One particular application considered here is for the feral swine (Sus scrofa), or wild boar, population control across the United States. Feral swine inflict serious and growing ecological and economic impacts to the farming and ranching ecosystems when their population continues to grow and invade new territory. These invasions ultimately impact the security, quality, and safety of the food supply and water resources coming from these regions. Recent and ongoing research is investigating the design and effectiveness of methods including traps, toxicant delivery systems, and bait formulas. However, these pre-existing methods predominately lack sufficient ability to prevent unintended actions on cohabitating species. Traditional and emerging baiting and bioagent delivery techniques, for example, can be augmented using proven embedded sensor and new signal processing technology as discussed here, to better prevent inadvertent treatment to other animals.

The system outlined here will be extremely useful for a myriad of agricultural and non-agricultural applications. Additionally, there are many alternative applications in settings where audio-video recognition platforms are needed, e.g., for perimeter and home security systems, border control, traffic monitoring, and active shooter localization. The systems may be used in conjunction with wildlife, as well as in connection with domestic or domesticated animals Data from the system may be obtained in various forms as desired. For example, the system may be configured to continually transmit data regarding the presence of target or non-target animal species, as well as the activation or inactivation of the animal species recognition system and/or of an associated wildlife management system. This data may be useful for ongoing tracking purposes, as well as to determine when the system may need to be restocked with power and/or supplies.

Automating the process of animal species-specific identification increases operational efficiency and enables significant cost savings for numerous types of wildlife management programs. While the economic damage caused by feral swine has grown significantly in the recent years, the market for automated feral swine recognition and baiting, hazing, or trapping systems is still in a nascent stage, both in the US and abroad. The market for such systems is fragmented with many competing products; no incumbent option has a dominant share.

The most popular pre-existing feral swine trapping systems are semi-automatic with one or more video cameras mounted on them. The system sends pictures or a short video clip of the monitored area within the trap. The user monitors the video and activates a trigger via a cellphone to close the trap as soon as feral swine are observed. Unlike many such earlier systems, the present system offers fully automated 24/7 operation, with much greater accuracy in identifying the target species while rejecting non-targeted species.

It is to be understood that the new methods and apparatus described here are not limited to the specific embodiments described above, but instead encompass any and all embodiments within the scope of the generic language of the following claims enabled by the embodiments described herein, or otherwise shown in the drawings or described above in terms sufficient to enable one of ordinary skill in the art to make and use the claimed subject matter.

We claim:

1. An animal species recognition system comprising a processor that uses a combination of audio and visual evidence to identify and recognize one or more animal species of interest in real time during deployment of the system.

2. The animal species recognition system of claim 1, further comprising at least one audio detection subsystem and at least one video subsystem, wherein the processor interprets and applies input from the at least one audio detection subsystem and the at least one video subsystem to identify and recognize the one or more animal species of interest.

3. The animal species recognition system of claim 2, further comprising at least one motion detection system.

4. The animal species recognition system of claim 2, wherein the processor further comprises an intelligent and trainable decision-making system using one or more classifiers trained to distinguish one or more targeted animal species from one or more other animal species.

5. The animal species recognition system of claim 4, wherein the system is configured to be fully autonomous and recognize an animal species of interest in real time without need for human intervention.

6. The animal species recognition system of claim 5, further comprising a power supply suitable to the intended use and environment.

7. The animal species recognition system of claim 6, wherein the system is configured to be fully autonomous in logging data of scene activity including at least one of the following:
estimated type of animal species of interest present during deployment; and
estimated quantity of animal species of interest present during deployment.

8. A wildlife management device activating system comprising the animal species recognition system of claim 7.

9. The wildlife management device activating system of claim 8, wherein the device activating system is configured to provide fully autonomous triggering of a wildlife management device.

10. The wildlife management device activating system of claim 9, wherein the device activating system is configured to allow fully autonomous triggering of a wildlife management device.

11. The wildlife management device activating system of claim 10, wherein the device activating system uses at least two sensory channels to trigger the wildlife management device selected from the group consisting of motion, audio, and visual evidence.

12. The wildlife management device activating system of claim 11, wherein the device activating system is configured to record device activating system status throughout the deployment.

13. The wildlife management device activating system of claim 10, wherein the wildlife management device is configured to control delivery of at least one selected from the group consisting of feed, dietary supplements, toxicants, vaccines, contraceptives, and other compositions useful for species control and management.

14. A method of animal species recognition comprising:
A. configuring an animal species recognition system comprising a processor that uses a combination of audio and visual evidence for recognizing one or more animal species of interest in real time during deployment, wherein the configuration includes the following capabilities:
1. observation of a surrounding environment to detect nearby target animal species;
2. determination of when a target animal species is located near the species recognition system; and
3. recordation of when a target animal species is located near the species recognition system;
B. deploying the animal species recognition system in a desired location; and
C. allowing the animal species recognition system to perform the steps in A.1. and A.2.

15. The method of animal species recognition of claim 14, wherein the method further comprises periodically confirming status of the animal species recognition system either remotely or at the deployment site.

16. The method of animal species recognition of claim 15, wherein the method further comprises periodically re-deploying the animal species recognition system in a different desired location.

17. A method of animal species control or management, comprising:
A. configuring a wildlife management device activating system in connection with a wildlife management device to perform the following steps:
1. observe a surrounding environment to detect target animal species near the wildlife management device;
2. determine when a target animal species is located near the wildlife management device; and
3. enable the wildlife management device only for the target animal species and not for any other non-target animal species;
B. deploying the wildlife management device activating system and the wildlife management device in a desired location; and
C. allowing the wildlife management device activating system to perform the steps in A.1. to A.3, thereby enabling the wildlife management device at appropriate times during the deployment.

18. The method of animal species control or management of claim 17, wherein the wildlife management device is configured to deliver one or selected from the group consisting of feed, dietary supplements, toxicants, disease vaccines, contraceptives, and other compositions useful for species control and management.

19. The method of animal species control or management of claim 17, wherein the wildlife management device is configured as a trapping device, a hazing device, or a perimeter control device.

20. The method of animal species control or management of claim 19, wherein the method further comprises periodically confirming the status of the wildlife management device activating system or the wildlife management device either remotely or at the deployment site.
